(19) United States
(12) Patent Application Publication
(10) Pub. No.: US 2006/0256442 A1
(43) Pub. Date: Nov. 16, 2006

(54) MICROLENS, OPTICAL PLATE, DIFFUSING PLATE, LIGHT GUIDE PLATE, BACKLIGHT, PROJECTION SCREEN, PROJECTION SYSTEM, ELECTRO-OPTICAL DEVICE, ELECTRONIC APPARATUS, AND METHOD FOR MANUFACTURING A MICROLENS

(75) Inventor: Hironori Hasei, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/382,343

(22) Filed: May 9, 2006

(30) Foreign Application Priority Data
May 10, 2005 (JP) 2005-136921

(51) Int. Cl. G02B 5/13; G02F 1/13357

(52) U.S. Cl. 359/619; 427/162; 427/163.3

(57) ABSTRACT

A method for manufacturing a microlens, comprises: discharging a liquid lens material on an optically transparent substrate; and hardening the lens material to provide the microlens; the microlens having different curvatures depending on where the lens material is discharged.

### BACKGROUND OF THE INVENTION

1. Technical Field

The present invention relates to a microlens, an optical plate, a diffusing plate, a light guide plate, a backlight, a projection screen, a projection system, an electro-optical device, an electronic apparatus, and a method for manufacturing a microlens.

2. Related Art

Backlights are used as light sources for notebook computers, mobile terminals, and other liquid crystal displays. High beam directivity and luminance are required for these applications.

Related art backlights have a microlens on their tops and a diffusing plate having micro projections on their bottoms to be in contact with the upper surface of a light guide plate. With this structure, a light beam emitted from an external light source is reflected for several times in the light guide plate and guided by the micro projections into the diffusing plate, so that the microlens can provide high beam directivity of the guided light. JP-A-10-39118 is an example of related art.

However, since the microlens of the related art diffusing plate is manufactured by molding or photolithography, it involves many manufacturing steps and high processing costs. JP-A-2005-71928 is another example of related art that shows a method for manufacturing a microlens easily by attaching a lens material to a substrate by droplet discharge and then hardening the material. There arises a problem again that beam directivity and luminance are hard to adjust with respect to multiple types of color elements, since the microlens is manufactured to have an almost identical curvature.

### SUMMARY

An advantage of the invention is to provide a microlens, an optical plate, a diffusing plate, a light guide plate, a backlight, a projection screen, a projection system, an electro-optical device, an electronic apparatus, and a method for manufacturing a microlens that provide high luminance and beam directivity with respect to multiple types of color elements.

A method for manufacturing a microlens according to one aspect of the invention includes: discharging a liquid lens material on an optically transparent substrate; and hardening the lens material to provide the microlens. Here, the microlens has different curvatures depending on where the lens material is discharged.

In this method, the lens material is discharged on the substrate in the step of discharging the lens material and hardened in the subsequent step of hardening the lens material. Here, the microlens is provided to have different curvatures depending on where the lens material is discharged in the step of discharging the lens material. By using the light-collection property of the microlens having different curvatures, it is possible to optimize beam directivity with respect to multiple types of color elements, for example.

The method for manufacturing a microlens may also include providing liquid-repellent treatment to a surface of the substrate prior to discharging the lens material. In this case, the lens material is discharged to a repellent-treated area and a repellent-treatment-free area in the step of discharging the lens material to provide the microlens having different curvatures.

A lens material portion having a high curvature attributed to a liquid-repellent effect is provided by making both the repellent-treated and repellent-treatment-free areas in the step of providing liquid-repellent treatment and discharging a lens material portion to the repellent-treated area. Another lens material portion having a lower curvature than that of the lens material portion discharged on the repellent-treated area is provided by discharging another lens material portion to the repellent-treatment-free area. By hardening these lens material portions, the microlenses having different curvatures can be easily provided.

The method for manufacturing a microlens may also include providing an optically transparent convex on the substrate and a resulting concave between one convex and another adjacent convex prior to discharging the lens material. In this case, the lens material is discharged to the convex and the concave in the step of discharging the lens material to provide the microlens having different curvatures.

The convex and the concave are provided on the substrate in this step. The pinning effect of the lens material restrains the edge of a lens material portion discharged on the convex from spreading at the upper rim of the convex. It is therefore possible to provide the microlens having a higher curvature than another lens material portion discharged on the concave. Furthermore, high luminance can be achieved by densely arranging the microlenses.

According to the method for manufacturing a microlens, the curvatures of the microlens may be set to provide an almost identical light-collection rate in a position at a predetermined distance from the substrate in a light-emitting direction.

Accordingly, for example, when light is emitted to color elements, the rate of collecting light emitted from the microlens is almost fixed on the surfaces of the color elements. It is therefore possible to achieve high luminance and reduce uneven luminance.

A microlens according to another aspect of the invention is manufactured by any of the above-described method for manufacturing a microlens.

Accordingly, with the microlens having different curvatures, it is possible to optimize beam directivity and luminance with respect to multiple types of color elements.

An optical plate according to yet another aspect of the invention includes: an optically transparent substrate; and a plurality of microlenses provided on the substrate. At least one of the plurality of microlenses has a different curvature from a curvature of the other microlenses.

Accordingly, with the microlenses having different curvatures provided on the substrate, it is possible to optimize beam directivity with respect to multiple color elements, for example.

The optical plate may also include a convex provided on the substrate and a microlens provided on the convex. In this case, the microlenses provided on the substrate have a different curvature from a curvature of the microlens provided on the convex.

Accordingly, for example, an almost identical light-collection rate can be achieved on the surfaces of the color elements with the microlens having a high curvature provided on the convex and the microlenses having a low curvature provided on the substrate.

In the optical plate, the microlenses may have different curvatures depending on their heights from the substrate.

Accordingly, since the microlenses have different curvatures depending on their heights from the substrate, it is possible to optimize beam directivity based on the heights of the microlenses.

In the optical plate, the microlenses may have lower curvatures as their heights from the substrate decrease.

Accordingly, since the microlenses have lower curvatures as their heights from the substrate decrease, it is possible to increase distance to a light-collecting point.

The optical plate may be a diffusing plate.

Accordingly, with the microlenses having different curvatures, for example, it is possible to make an optimum adjustment to provide an almost identical rate to collect light emitted to color elements.

The optical plate may be a light guide plate also including: a reflector reflecting light emitted from an external light source; and a light guide part guiding the light emitted from the external light source to an entire surface thereof.

Accordingly, with the microlenses having different curvatures, it is possible to enhance scattering properties and improve beam directivity.

In the light guide plate, the microlenses may be provided to have higher curvatures with distance from the external light source emitting light from a side of the substrate.

Accordingly, with the microlenses having higher curvatures with distance from the external light source, it is possible to prevent a reduction in the amount of light and provide even luminance.

A projection screen according to still another aspect of the invention includes a Fresnel lens, and a lenticular sheet to which any of the above-described optical plate is applied.

Accordingly, a projection screen having good scattering properties can be provided.

A projection system according to yet another aspect of the invention includes the above-described projection screen.

Accordingly, a projection system that enhances visibility of images projected and provides high-quality images can be provided.

A backlight according to still another aspect of the invention includes at least one of the above-described optical plate and the above-described light guide plate.

Accordingly, a backlight that optimizes a light scattering efficiency can be provided with the microlens having different curvatures.

An electro-optical device according to still another aspect of the invention includes the above-described backlight.

Accordingly, an electro-optical device having high beam directivity can be provided.

An electronic apparatus according to still further aspect of the invention includes the above-described electro-optical device.

Accordingly, an electronic apparatus having high beam directivity can be provided.

### BRIEF DESCRIPTION OF THE DRAWINGS

The invention will be described with reference to the accompanying drawings, wherein like numbers reference like elements.

FIG. 1 is a diagram schematically showing an optical plate.

FIG. 2 is a sectional view schematically showing a diffusing plate.

FIG. 3 is a sectional view schematically showing a light guide plate.

FIG. 4 is a sectional view schematically showing a backlight.

FIG. 5 is a sectional view schematically showing a liquid crystal display as an electro-optical device.

FIG. 6 is a diagram schematically showing a mobile terminal as an electronic apparatus.

FIG. 7 is a sectional view schematically showing a projection screen.

FIG. 8 is a diagram schematically showing a projection system.

FIGS. 9A and 9B show a structure of a discharge head.

FIG. 9A is a perspective view with a part thereof broken down.

FIG. 9B is a sectional view showing major elements thereof.

FIGS. 10A through 10F show steps to manufacture a microlens.

FIG. 11 is a sectional view schematically showing an optical plate according to one modification.

FIGS. 12A through 12F show steps to manufacture a microlens according to the modification.

### DESCRIPTION OF THE EMBODIMENTS

Embodiments of the invention will be described with reference to the accompanying drawings.

Structure of Optical Plate

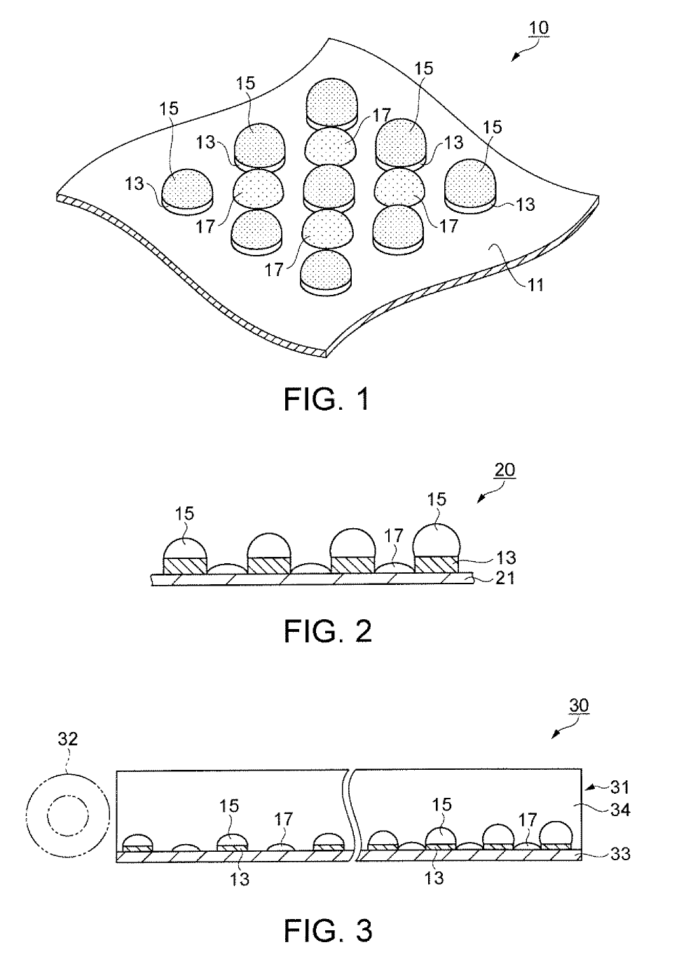

The structure of an optical plate according to one embodiment of the invention will be first described. FIG. 1 is a diagram schematically showing an optical plate 10.

Referring to FIG. 1, the optical plate 10 includes an optically transparent substrate 11, an optically transparent convex 13 provided on the substrate 11, a microlens 15 provided on the convex 13, and a microlens 17 provided on the substrate 11.

The substrate 11 is optically transparent and made of quartz, glass, acrylic resin, or polycarbonate, polyester or other transparent resin, for example.

The convex 13 is almost columnar in shape with an almost flat top. The convex 13 is provided in a plural number at almost even intervals on the substrate 11. The convex 13 is optically transparent and made of, for example, acrylic resin, polyester resin, urethane resin, epoxy resin, polycarbonate resin, styrene resin, or novolac resin.

The microlens 15 is provided on each convex 13 to have different curvatures depending on where it is provided.

The microlens 17 is provided on the substrate 11 and is almost hemispherically shaped. The microlens 17 is provided almost evenly in the microlens 15 array provided almost evenly.

The microlenses 15 and 17 are made of, for example, ultraviolet-curing acrylic resin or ultraviolet-curing epoxy resin with a precursor, such as a polyimide precursor.

The ultraviolet-curing resin used here includes at least one of a prepolymer, oligomer, and monomer, and also includes a photopolymerization initiator.

Examples of the prepolymer or oligomer included in the ultraviolet-curing acrylic resin used here may include the following: epoxy acrylates, urethane acrylates, polyester acrylates, polyether acrylates, spiroacetal acrylates and other acrylates; and epoxy methacrylates, urethane methacrylates, polyester methacrylates, polyether methacrylates and other methacrylates.

Examples of the monomer may include the following: 2-ethylhexyl acrylate, 2-ethylhexyl methacrylate, 2-hydroxyethyl acrylate, 2-hydroxyethyl methacrylate, N-vinyl-2-pyrrolidone, carbitol acrylate, tetrahydrofurfuryl acrylate, isobornyl acrylate, dicyclopentenyl acrylate, 1,3-butanediol acrylate and other monofunctional monomers; 1,6-hexanediol diacrylate, 1,6-hexanediol methacrylate, neopentyl glycol acrylate, polyethylene glycol diacrylate, pentaerythritol diacrylate and other difunctional monomers; and trimethylolpropane triacrylate, trimethylolpropane trimethacrylate, pentaerythritol triacrylate, dipentaerythritol hexaacrylate and other multifunctional monomers.

Examples of the photopolymerization initiator used here may include the following: 2,2-dimethoxy-2-phenylacetophenone and other acetophenones; alpha-hydroxyisobutylphenone, p-isopropyl-alpha-hydroxyisobutylphenone and other butylphenones; p-tert-butyldichloroacetophenone, alpha, alpha- dichloro-4-phenoxyacetophenone and other halogenated acetophenones; benzophenone, N,N-tetraethyl-4,4-diaminobenzophenone and other benzophenones, benzyl, benzyl dimethyl ketal and other benzyls; benzoin, benzoin alkyl ether and other benzoins; 1-phenyl-1,2-propanedione-2-(o-ethoxycarbonyl)oxime and other oximes, 2-methylthioxanthone, 2-chlorothioxanthone and other xanthones; benzoin ether, isobutyl benzoin ether and other benzoin ethers; Michler's ketones; and other radically polymerizable compounds. The ultraviolet-curing acrylic resin that has been cured is advantageous in that it has high transparency.

Examples of the polyimide precursor may include polyamic acids and polyamic-acid long-chain alkyl esters. A polyimide resin produced by thermally hardening the polyimide precursor has 80% or more transparency in a visible light region and a high refractive index of 1.7 to 1.9, thereby providing a large lens effect.

Structure of Diffusing Plate

The structure of a diffusing plate as an optical plate according to an embodiment of the invention will now be described. FIG. 2 is a sectional view schematically showing the diffusing plate. This diffusing plate 20 makes light from a light source (not shown) emitted evenly with respect to color elements.

Referring to FIG. 2, the diffusing plate 20 includes an optically transparent substrate 21, the optically transparent convex 13 provided on the substrate 21, the microlens 15 provided on the convex 13, and the microlens 17 provided on the substrate 21.

The substrate 21 is optically transparent and made of quartz, glass, acrylic resin, or polycarbonate, polyester or other transparent resin, for example. A matte finish is applied to the surface of the substrate 21 in consideration of its light-collection property.

The convex 13 is almost columnar in shape with an almost flat top. The convex 13 is provided in a plural number at almost even intervals on the substrate 21. The convex 13 is optically transparent and made of, for example, acrylic resin, polyester resin, urethane resin, epoxy resin, polycarbonate resin, styrene resin, or novolac resin.

The microlens 15 is provided on each convex 13 to have different curvatures depending on where it is provided. For example, the microlens 15 is arranged in a way that its curvature increases with distance from a light source (not shown).

The microlens 17 is provided on the substrate 21 and is almost hemispherically shaped. The microlens 17 is provided almost evenly in the microlens 15 array provided almost evenly.

The microlenses 15 and 17 are made of, for example, ultraviolet-curing acrylic resin or ultraviolet-curing epoxy resin with a precursor, such as a polyimide precursor. Since the materials of the microlenses 15 and 17 are similar to the ones included in the above-described optical plate 10, a detail description thereof is omitted.

Structure of Light Guide Plate

The structure of a light guide plate as an optical plate according to an embodiment of the invention will now be described. FIG. 3 is a sectional view schematically showing the light guide plate. This light guide plate 30 diffuses light from an external light source 32 provided to the side of the light guide plate 30 to the entire surface of the light guide plate 30.

Referring to FIG. 3, the light guide plate 30 includes an optically transparent substrate 34, a reflector 33 reflecting light from the light source 32 in a direction toward a light guide part 31, the convex 13 provided on the reflector 33, the microlens 15 provided on the convex 13, and the microlens 17 provided on the reflector 33.

The light guide part 31 and the reflector 33 are unified by welding with pressure the light guide part 31 with the substrate 34 softened and the reflector 33 provided with the microlenses 15 and 17 and then hardening them.

The substrate 34 has an almost flat surface and is optically transparent. The substrate 34 is made of quartz, glass, acrylic resin, or polycarbonate, polyester or other transparent resin, for example.

The convex 13 is almost columnar in shape with an almost flat top. Referring to FIG. 3, the interval between one convex 13 and another adjacent convex 13 decreases with distance from the external light source 32. The convex 13 is optically transparent and made of, for example, acrylic resin, polyester resin, urethane resin, epoxy resin, polycarbonate resin, styrene resin, or novolac resin.

The microlens 15 is provided to have different curvatures depending on where it is provided. For example, the microlens 15 is arranged in a way that its curvature increases with distance from the external light source 32.

The microlens 17 provided on the reflector 33 is almost hemispherically shaped. The microlens 17 is provided almost evenly in the microlens 15 array provided almost evenly.

The microlenses 15 and 17 are made of, for example, ultraviolet-curing acrylic resin or ultraviolet-curing epoxy resin with a precursor, such as a polyimide precursor. Since their materials are similar to the ones included in the above-described optical plate 10, a detail description thereof is omitted.

Structure of Backlight

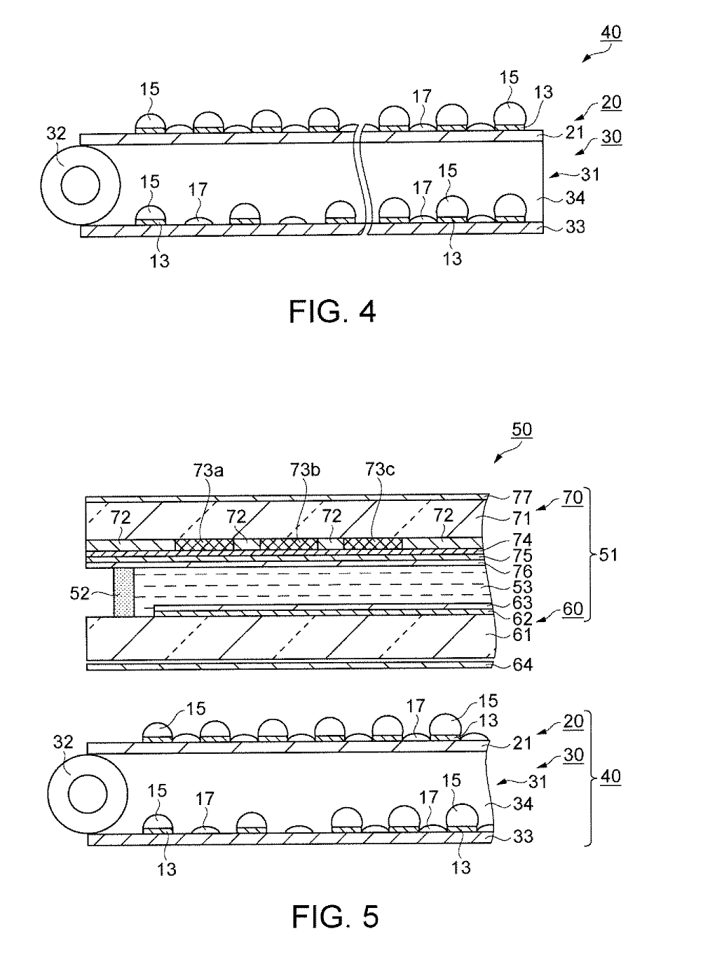

A backlight according to an embodiment of the invention will now be described. FIG. 4 is a sectional view schematically showing the backlight.

Referring to FIG. 4, this backlight 40 includes the light guide plate 30 disposed near the external light source 32, and the diffusing plate 20 disposed to face the light guide plate 30. The external light source 32 is a lighting device, such as a cold cathode fluorescent tube. Light from the external light source 32 is spread by the light guide plate 30 to its entire surface and emitted on the diffusing plate 20. Upon receiving the light from the light guide plate 30, the diffusing plate 20 is irradiated with the light evenly through the microlens 15. The microlens 15 is arranged in a way that its curvature increases with distance from the external light source 32. Therefore, the microlens 15 reflects the light emitted from the external light source 32 to emit the light from the entire surface of the light guide part 31.

Structure of Electro-Optical Device

An electro-optical device according to an embodiment of the invention will now be described. FIG. 5 is a sectional view schematically showing a liquid crystal display as the electro-optical device.

Referring to FIG. 5, this electro-optical device 50 includes the backlight 40 emitting light, and a liquid crystal display unit 51 displaying an image in response to the light emitted from the backlight 40.

The backlight 40 includes the external light source 32, the light guide plate 30 disposed near the external light source 32, and the diffusing plate 20 disposed to face the light guide plate 30.

In the liquid crystal display unit 51, a lower substrate portion 60 is provided near the diffusing plate 20 included in the backlight 40, while an upper substrate portion 70 is provided to face the lower substrate portion 60. There is a gap defined by a sealant 52 between the lower substrate portion 60 and the upper substrate portion 70. Sealed in the gap is a liquid crystal material 53.

The lower substrate portion 60 includes a lower transparent substrate 61, a display electrode 62 provided on the upper surface of the lower transparent substrate 61, and a light distribution film 63 provided on the upper surface of the display electrode 62. Provided on the side of the lower transparent substrate 61 remote from the display electrode 62 is a polarizer 64.

The upper substrate portion 70 includes an upper transparent substrate 71, a black matrix 72 provided on the side of the upper transparent substrate 71 facing the lower transparent substrate 61, and color filters 73a (R), 73b (G), 73c (B) as color elements in regions defined by the black matrix 72. The upper substrate portion 70 also includes a protection film 74 provided on the upper surfaces of the black matrix 72 and the color filters 73a, 73b, 73c, a common electrode 75 provided on the upper surface of the protection film 74, and a light distribution film 63 provided on the upper surface of the common electrode 75. Provided on the side of the upper transparent substrate 71 remote from the color filters 73a, 73b, 73c is a polarizer 77.

The lower substrate portion 60 and the upper substrate portion 70 are bonded by the adhesion of the sealant 52. Sealed in a gap between the substrate portions 60 and 70 defined by the height of the sealant 52 is the liquid crystal material 53.

Structure of Electronic Apparatus

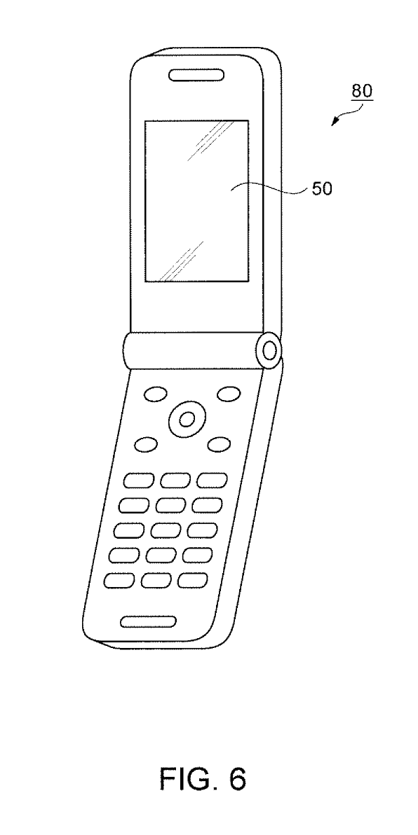

An electronic apparatus according to an embodiment of the invention will now be described. FIG. 6 is a diagram schematically showing a mobile terminal as the electronic apparatus. Referring to FIG. 6, the electro-optical device 50 is incorporated as a display of this mobile terminal 80.

Structure of Projection Screen

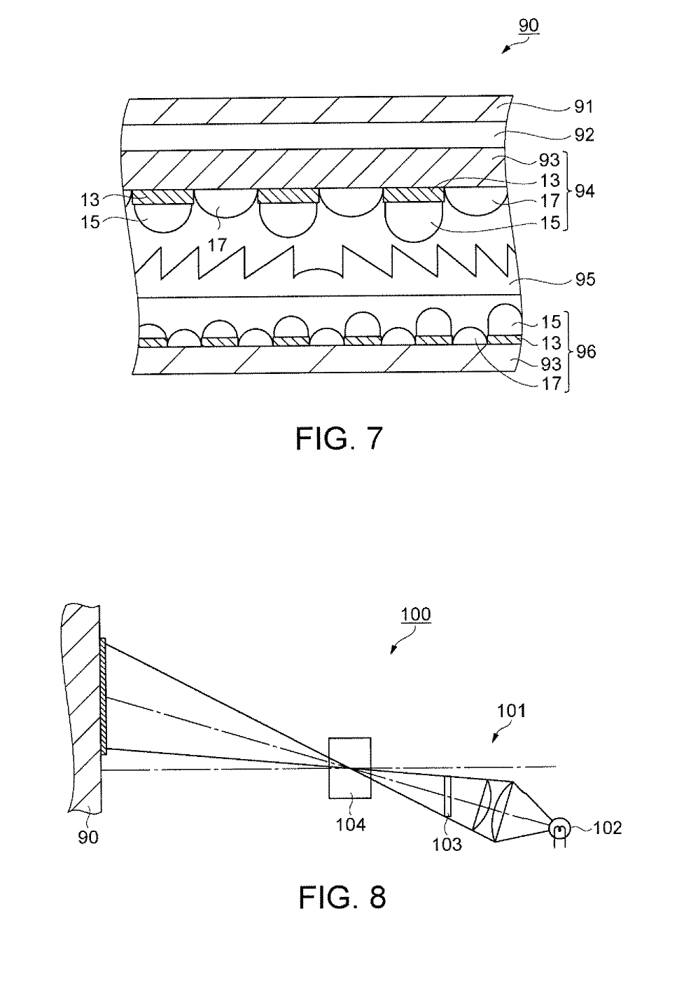

A projection screen according to an embodiment of the invention will now be described. FIG. 7 is a sectional view schematically showing the projection screen (hereinafter simply referred to as the “screen”).

Referring to FIG. 7, this screen 90 includes a film substrate 91, an adhesive layer 92 provided on the film substrate 91, a lenticular sheet 94 bonded by the adhesion of the adhesive layer 92 to serve as the optical plate 10, a Fresnel lens 95 provided on the lenticular sheet 94, and a scattering film 96 provided on the Fresnel lens 95 to serve as the optical plate.

The lenticular sheet 94 includes an optically transparent substrate 93, a plurality of convexes each corresponding to the convex 13 provided on the substrate 93, and the microlens 15 provided on each convex 13. The microlens 15 has different curvatures depending on where it is provided. For example, the curvature of the microlens 15 increases with distance outward from the center of the screen 90. Also, the microlens 17 is provided at almost even intervals on the substrate 93.

The scattering film 96 includes the optically transparent substrate 93, a plurality of convexes each corresponding to the convex 13 provided on the substrate 93, and the microlens 15 provided on each convex 13. Also, the microlens 17 is provided at almost even intervals on the substrate 93.

The screen 90 according to the present embodiment is not limited to the example shown in FIG. 7. For example, it may include either the lenticular sheet 94 or the scattering film 96. Even in this case, the scattering function of the lenticular sheet 94 is good enough to enhance the quality of images projected on the screen. Meanwhile, the scattering function of the scattering film 96 is good enough to scatter incoming (reflected) light that has been passed through the film and reflected toward the film, thereby preventing regular reflection. It is therefore possible to enhance visibility of images projected on the screen.

Structure of Projection System

A projection system according to an embodiment of the invention will now be described. FIG. 8 is a diagram schematically showing the projection system.

Referring to FIG. 8, this projection system 100 includes a projector 101 and the screen 90 shown in FIG. 7. The projector 101 includes an external light source 102, a liquid crystal light valve 103 disposed on the optical axis of light emitted from the light source 102 to modulate the light, and an imaging lens (imaging optics) 104 providing an image of the light that has passed through the liquid crystal light valve 103. The liquid crystal light valve 103 modulates light with three (R, G, B) plates, for example. Here, a device to modulate light is not limited to the liquid crystal light valve 103. A device that drives a micro reflector (by controlling its reflection angle) to modulate light from the light source may be used instead.

Method for Manufacturing a Microlens

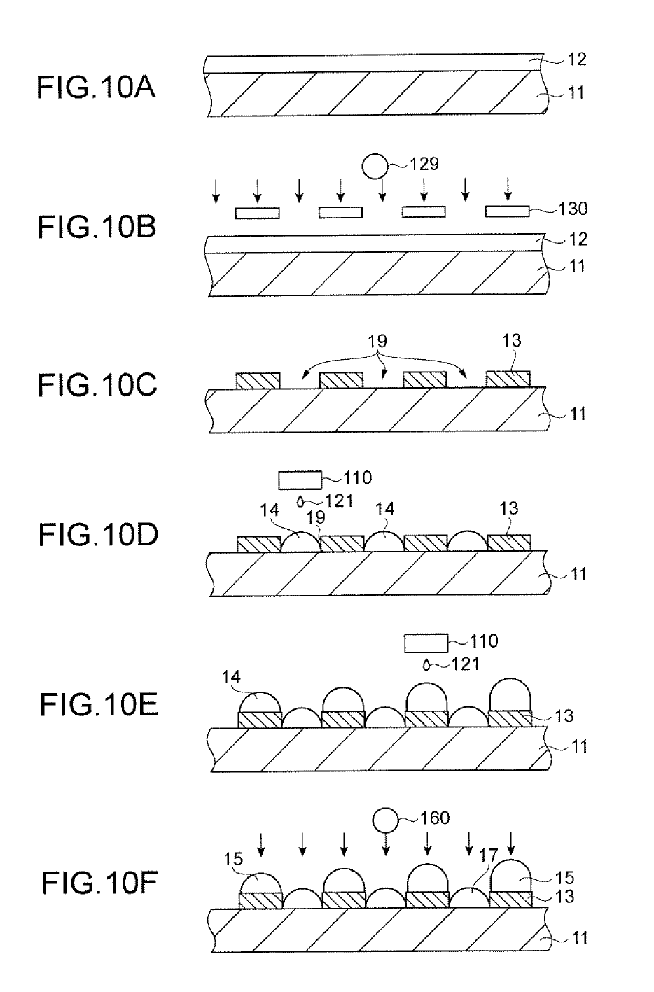

A method for manufacturing a microlens according to an embodiment of the invention will now be described. FIGS. 10A through 10F show steps to manufacture a microlens.

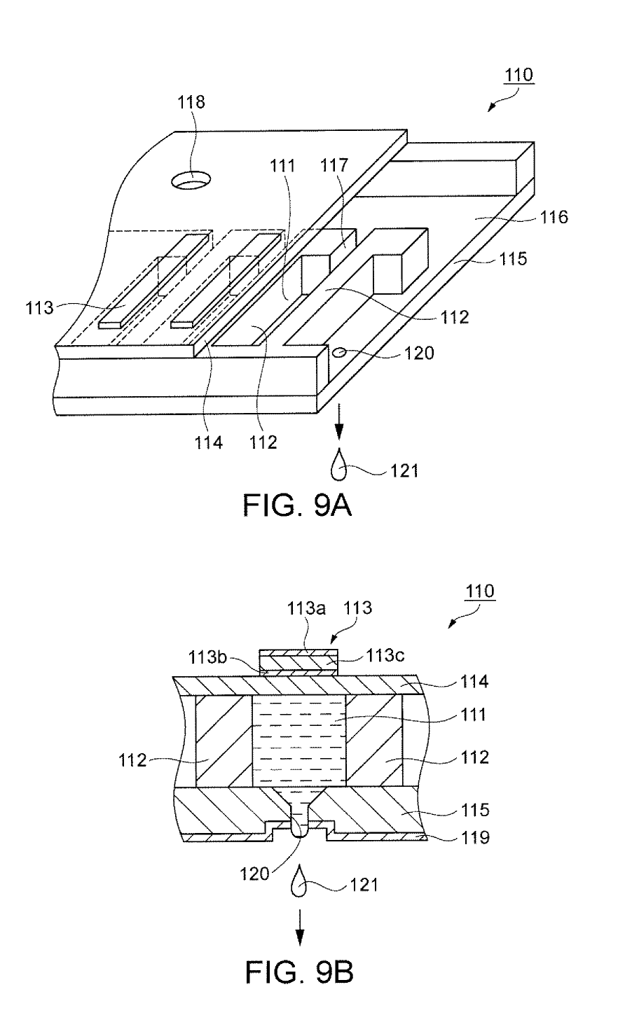

A discharge head 110 shown in FIGS. 10A through 10F has a structure shown in FIGS. 9A and 9B. FIG. 9A is a perspective view with a part thereof broken down. FIG. 9B is a sectional view showing major elements thereof.

Referring to FIG. 9A, the discharge head 110 includes a vibrating plate 114 and a nozzle plate 115. Provided between the vibrating plate 114 and the nozzle plate 115 is a reservoir 116 in which a functional liquid supplied through a hole 118 always fills. Also provided between the vibrating plate 114 and the nozzle plate 115 is a plurality of partitions 112. An area surrounded by the vibrating plate 114, the nozzle plate 115, and a pair of partition walls 112 is a cavity 111. Provided correspondingly to the nozzle 120, the cavity 111 is provided in the same number as the nozzle 120. The functional liquid is supplied from the reservoir 116 to the cavity 111 through a supply opening 117 placed between a pair of partition walls 112.

Referring to FIG. 9B, an oscillator 113 corresponding to the cavity 111 is mounted on the vibrating plate 114. The oscillator 113 includes a piezoelectric element 113c and a pair of electrodes 113a and 113b sandwiching the piezoelectric element 113c. By giving a driving voltage to the pair of electrodes 113a and 113b, the functional liquid is discharged as a droplet 121 through the corresponding nozzle 120. Provided around the nozzle 120 is a functional-liquid-repellant layer 119. It is a Ni-tetrafluoroethylene eutectoid plated layer, for example, that prevents any curved discharge of the droplet 121 and clogging of the nozzle 120. Here, an electrothermal converting element may be used instead of the oscillator 113 to discharge the functional liquid. In this case, thermal expansion of the material liquid driven by the element is used to discharge the material liquid.

Referring now to FIGS. 10A through 10F, the method for manufacturing the microlenses 15 and 17 will be described.

Referring to FIG. 10A, a convex material 12 is provided to an almost even thickness on the upper surface of the substrate 11. The substrate 11 has an almost flat surface and is optically transparent. The substrate 11 is made of quartz, glass, acrylic resin, or polycarbonate, polyester or other transparent resin, for example. The convex material 12 is optically transparent and made of, for example, acrylic resin, polyester resin, urethane resin, epoxy resin, polycarbonate resin, styrene resin, or novolac resin.

In the subsequent step of making a concave-convex pattern shown in FIG. 10B, the convex 13 as shown in FIG. 10C is provided with an exposure device 129, a mask 130, and a developer, for example. Making the convex 13 provides a concave 19 between one convex 13 and another adjacent convex 13.

In the subsequent step of providing liquid-repellent treatment shown in FIG. 10C, liquid-repellent treatment is provided to the surface of the concave 19 and the convex 13 of the substrate 11. Here, the liquid-repellent treatment may be provided only to the surface of the substrate 11 where the concave 19 is, and treatment to the convex 13 can be omitted. For the liquid-repellent treatment, CF₄ is used, for example.

In the subsequent step of discharging a lens material to the concave 19 shown in FIG. 10D, the droplet 121 of a liquid lens material 14 is discharged from the discharge head 110 toward the concave 19 to attach the lens material 14 to the concave 19. Examples of the lens material 14 may include ultraviolet-curing acrylic resin and ultraviolet-curing epoxy resin with a precursor, such as a polyimide precursor.

In the subsequent step of discharging the lens material to the convex 13 shown in FIG. 10E, the droplet 121 of the liquid lens material 14 is discharged from the discharge head 110 toward the top of the convex 13 to attach the lens material 14 to the top of the convex 13. Examples of the lens material 14 may include ultraviolet-curing acrylic resin and ultraviolet-curing epoxy resin with a precursor, such as a polyimide precursor. Here, the amount of discharge is controlled in consideration of desirable curvatures of the microlens 15 depending on the position of the convex 13 to which the material is discharged. Furthermore, the amount and speed of discharge are controlled to an extent that the lens material 14 does not fall down on the substrate 11 from the top of the convex 13. The greater the amount of discharge, the higher the curvature of the microlens 15.

In the subsequent step of hardening the lens material shown in FIG. 10F, the lens material 14 is hardened by being irradiated with ultraviolet rays from an ultraviolet radiation device 160, thereby providing the microlenses 15 and 17.

The present embodiment provides the following effects.

(1) Since the microlens 15 is provided to have desirable curvatures, it is possible to optimize scattering properties with respect to a plurality of color elements.

(2) Since the diffusing plate 20 is provided with the microlenses 15 and 17 that are densely arranged, it is possible to efficiently collect light emitted from the external light source 32 and provide a high-luminance display.

(3) Since the light guide plate 30 is provided in a way that the interval between one microlens 15 and another adjacent microlens 15 and the interval between one microlens 17 and another adjacent microlens 17 decrease with distance from the external light source 32, it is possible to enhance scattering properties on the entire surface of the light guide part 31.

It is understood that the invention is not limited to the embodiments described above, and the following modifications can be made.

First Modification

While the convex 13 is provided by photolithography in the step shown in FIG. 10B, the invention is not limited to this. For example, the convex 13 and the concave 19 may be provided by pressing the convex material 12 provided on the substrate 11 with a die or the like. The microlenses 15 and 17 may be provided to the convex 13 and the concave 19 in this manner.

Second Modification

While the lens material 14 is discharged on the concave 19 and the convex 13 and then hardened in the steps shown in FIGS. 10D through 10F, the invention is not limited to this. For example, the lens material 14 discharged on the concave may be hardened directly after it is discharged. Accordingly, it is possible to reduce a rate of defects arising between the steps because a portion of the lens material 14 discharged on the concave 19 and another portion of the lens material 14 discharged on the convex 13 get together.

Third Modification

While the microlens 17 is provided to have an almost fixed curvature in the steps shown in FIGS. 10D and 10F, the microlens 17 may be provided to have different curvatures. It is therefore possible to optimize scattering properties more precisely.

Fourth Modification

While the micro lens 17 is provided between one convex 13 and another adjacent convex 13 in the steps shown in FIGS. 10D and 10F, this can be omitted. Even in this case, it is possible to optimize scattering properties.

Fifth Modification

While the convex 13 is provided to have an almost fixed diameter in the above-described embodiment, the invention is not limited to this. For example, the convex 13 may have different diameters. It is therefore possible to easily provide the microlens 15 having different curvatures.

Sixth Modification

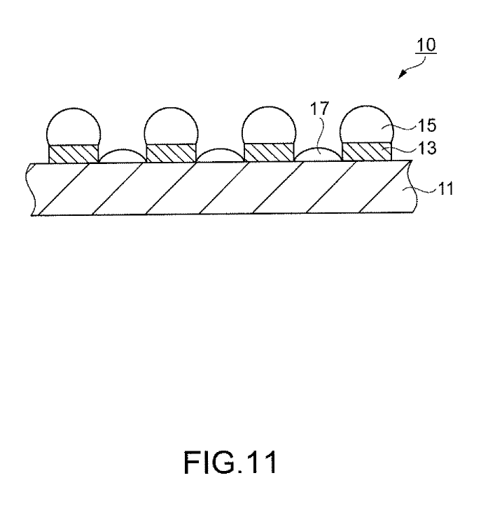

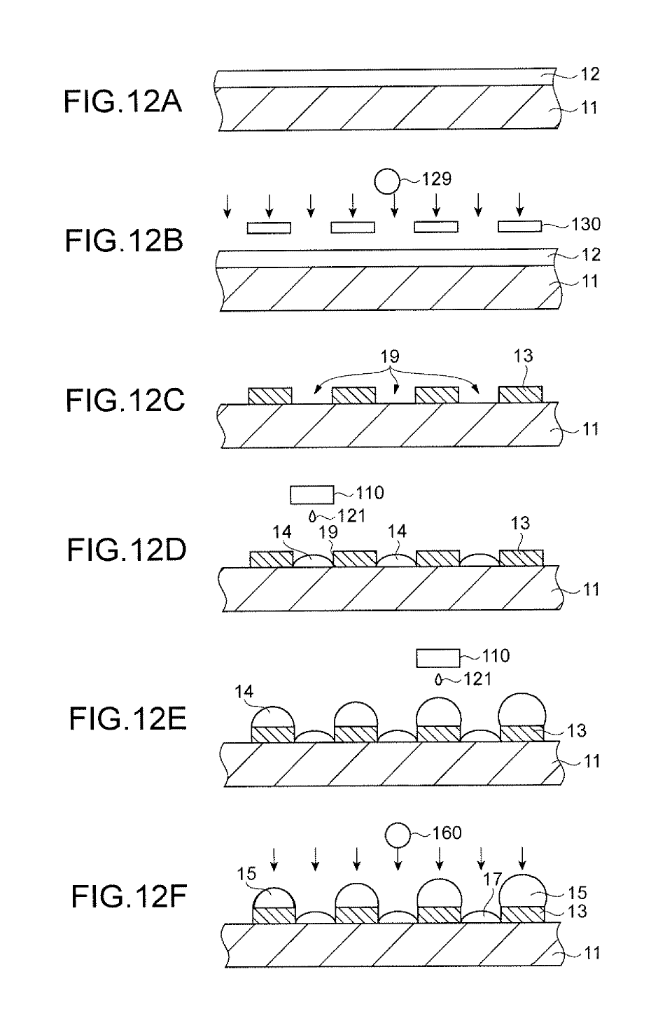

While the microlens 17 on the convex 13 included in the diffusing plate 20 has different curvatures, the invention is not limited to this. For example, the microlens may have different curvatures depending on its height as shown in FIG. 11. Referring to FIG. 11, the curvature of the microlens 17 is made smaller than the curvature of the microlens 15. Accordingly, for example, it is possible to equalize light-collection distance to a display, such as a display panel, and provide a display with even luminance. FIGS. 12A through 12F show steps to manufacture a microlens according to the present modification.

The steps shown in FIGS. 12A through 12C are similar to the steps shown in FIGS. 10A through 10C, and a description thereof is omitted.

In the step of discharging the lens material to the concave 19 shown in FIG. 12D, the droplet 121 of the liquid lens material 14 is discharged from the discharge head 110 toward the concave 19 to attach the lens material 14 to the concave 19. The discharge of the lens material 14 is controlled in consideration of the light-collection distance, so that a smaller curvature than that of the microlens 15 will be provided.

In the subsequent step of discharging the lens material to the convex 13 shown in FIG. 12E, the droplet 121 of the liquid lens material 14 is discharged from the discharge head 110 toward the top of the convex 13 to attach the lens material 14 to the top of the convex 13. Here, the amount and speed of discharge are controlled to an extent that the material does not fall down on the substrate 11. The microlens 15 having an almost fixed curvature is provided by controlling the amount of discharge to be almost fixed.

In the subsequent step of hardening the lens material shown in FIG. 12F, the lens material 14 is hardened by being irradiated with ultraviolet rays from the ultraviolet radiation device 160, thereby providing the microlenses 15 and 17.

What is claimed is:

1. A method for manufacturing a microlens, comprising:
discharging a liquid lens material on an optically transparent substrate; and
hardening the lens material to provide the microlens;
the microlens having different curvatures depending on where the lens material is discharged.

2. The method for manufacturing a microlens according to claim 1, further comprising:
providing liquid-repellent treatment to a surface of the substrate prior to discharging the lens material;
the lens material being discharged to a repellent-treated area and a repellent-treatment-free area in discharging the lens material to provide the microlens having different curvatures.

3. The method for manufacturing a microlens according to claim 1, further comprising:
providing an optically transparent convex on the substrate and a resulting concave between one convex and another adjacent convex prior to discharging the lens material,
the lens material being discharged to the convex and the concave in discharging the lens material to provide the microlens having different curvatures.

4. The method for manufacturing a microlens according to claim 1,
the curvatures of the microlens being set to provide an almost identical light-collection rate in a position at a predetermined distance from the substrate in a light-emitting direction.

5. A microlens manufactured by the method for manufacturing a microlens according to claim 1.

6. An optical plate, comprising:
an optically transparent substrate; and
a plurality of microlenses provided on the substrate;
at least one of the plurality of microlenses having a different curvature from a curvature of the other microlenses.

7. The optical plate according to claim 6, further comprising:
a convex provided on the substrate; and
a microlens provided on the convex;
the microlenses provided on the substrate having a different curvature from a curvature of the microlens provided on the convex.

8. The optical plate according to claim 6, the microlenses having different curvatures depending on heights thereof from the substrate.

9. The optical plate according to claim 8,
the microlenses having lower curvatures as heights thereof from the substrate decrease.

10. The optical plate according to claim 7,
the optical plate being a diffusing plate.

11. The optical plate according to claim 10,
the optical plate being a light guide plate further including:
a reflector reflecting light emitted from an external light source; and
a light guide part guiding the light emitted from the external light source to an entire surface thereof.

12. The optical plate according to claim 11,
the microlenses having higher curvatures with distance from the external light source emitting light from a side of the substrate in the light guide plate.

13. A projection screen, comprising:
a Fresnel lens; and
a lenticular sheet to which the optical plate according to claim 6 is applied.

14. A projection system, comprising:
the projection screen according to claim 13.

15. A backlight, comprising:
at least one of the optical plate according to claim 6 and the light guide plate according to claim 12.

16. An electro-optical device, comprising:
the backlight according to claim 15.

17. An electronic appliance, comprising:
the electro-optical device according to claim 16.
